(19) United States
(12) Patent Application Publication
(10) Pub. No.: US 2007/0000672 A1
(43) Pub. Date: Jan. 4, 2007

(54) Soil cultivation appliance, especially a hoe, operated in an electromotive manner

(76) Inventor: Karl Muller, Bad Bruckenau (DE)

Correspondence Address: Breiner & Breiner, 115 North Henry Street, P O Box 19290, Alexandria, VA, 22320-0290, US

(21) Appl. No.: 10/551,384

(22) PCT Filed: Apr. 3, 2003
(86) PCT No.: PCT/DE04/00693

§ 371 Date: Nov. 14, 2005

(30) Foreign Application Priority Data
Apr. 30, 2003 (DE) 203 05 393.1
Feb. 4, 2004 (DE) 20 2004 001 637.0

(51) Int. Cl. A01B 49/02; A01B 5/00

(52) U.S. Cl. 172/157

(57) ABSTRACT

An electromotive soil cultivation appliance for cultivating soil in the fields of agriculture and horticulture is described, particularly a rotary hoe with an asynchronous rotary current motor for driving a rotatable cultivating tool. The soil cultivation appliance includes a frequency converter for generating a drive voltage of adjustable frequency for the rotary current motor, wherein the frequency converter is connected to a manually operated adjusting device for varying the frequency of the drive voltage. The rotary current motor provides that a nearly constant torque of the rotary current motor is maintained over a broad range of speeds of the motor that can be adjusted by means of the adjusting device. The appliance is a user-friendly soil cultivation appliance that makes it possible to achieve an efficient cultivation of the soil in lower speed ranges.

### TECHNICAL SCOPE

The present invention pertains to an electromotive soil cultivation appliance for cultivating soils in the field of agriculture and horticulture, particularly a rotary hoe with an asynchronous rotary current motor for driving a rotatable cultivating tool.

Motor-driven hand-operated soil cultivation appliances are also referred to as rotary hoes or tillers and nowadays considered standard equipment for horticulture businesses, allotment holders and vineyards. Soil cultivation appliances of this type contain a rotary cultivating tool that digs into and thusly cultivates the soil. Until now, the rotary drives of the cultivating tool were primarily realized in the form of internal combustion engines mounted on the undercarriage of the soil cultivation appliance. Internal combustion engines, however, not only emit much noise, but also significant quantities of harmful substances. In addition, a high motor speed is required in order to cultivate the soil with a sufficiently high torque.

In the meantime, hand-operated soil cultivation appliances in which electric motors are used for driving the cultivating tool are also available for agricultural or horticultural applications. For example, DE 42 10 816 A1 discloses a hand-operated soil cultivation appliance in which the drive is realized in the form of a rotary current motor. The tool driven by the rotary current motor can be adjusted to two different tool widths by respectively removing or reattaching outer tool segments. However, the operation with a narrower tool width requires a different torque than the operation with a wider tool width. Consequently, the rotary current motor can be changed over between two speed ranges, in which different torques are generated.

One frequent problem with conventional soil cultivation appliances is that an efficient cultivation can only be achieved if the soil has a certain consistency. In addition, it is sometimes complicated for the user to operate the appliance. The electric motors used in soil cultivation appliance of this type also need to have a compact design and a low price.

Based on this state of the art, the present invention aims to disclose a hand-operated electromotive soil cultivation appliance for cultivating soils in the fields of agriculture and horticulture, particularly a rotary hoe or tiller that only emits small quantities of harmful substances, allows an effective and user-friendly cultivation of soils of different consistencies and can be manufactured in a cost-efficient fashion.

### DESCRIPTION OF THE INVENTION

This objective is attained with the soil cultivation appliance according to claim 1. Advantageous variations and additional developments of the soil cultivation appliance form the objects of the dependent claims or can be inferred from the following description and the embodiments.

The hand-operated electromotive soil cultivation appliance according to the invention comprises an asynchronous rotary current motor for driving a rotatable cultivating tool. The soil cultivation appliance comprises a frequency converter for generating a drive voltage of adjustable frequency for the rotary current motor, wherein the frequency converter is connected to a manually operated adjusting device for varying the frequency of the drive voltage. The rotary current motor is realized in such a way, preferably due to a suitably chosen number of poles and turns of the stator, that a nearly constant torque of the rotary current motor is maintained over a broad range of motor speeds that can be adjusted by means of the adjusting device. The broad speed range preferably covers speeds between 20 and more than 2000 rpm, particularly up to approximately 6500 rpm.

An even more advantageous speed range of the rotary current motor covers speeds between 10 and more than 3000 rpm.

An approximately constant torque over a broad speed range can be ensured by suitably adapting the number of poles on one hand and the number of turns of the stator of the rotary current motor on the other hand.

Commercially available low-cost rotary current motors are designed for a certain speed, i.e., their torque decreases significantly above and below this speed. The torque in the lower speed range can be raised by increasing the number of poles of conventional rotary current motors. The torque in the upper speed range can be increased by reducing the number of turns and thusly lowering the inductive resistance in this upper speed range. Another option for raising the torque in the lower speed range consists of increasing the number of turn grooves on the stator, i.e., utilizing a stator with a larger number of grooves. One of the aforementioned measures or a combination of the aforementioned measures make(s) it possible to realize conventional low-cost and light-weight rotary current motors such that they are suitable for use as rotary current motors in the described soil cultivation appliance.

The option of varying the frequency generated by the frequency converter and therefore the speed of the rotary current motor that preferably consists of a three-phase rotary current motor makes it possible to also variably utilize the described soil cultivation appliance with a nearly constant torque at comparatively low speeds. The inventor recognized that a very effective soil cultivation is frequently achieved at lower speeds, particularly when cultivating hard or stony soils. The option of regulating the speed over a broad range without causing a significant decrease of the torque makes it possible to effectively cultivate soils in dependence on their consistency.

The speed is preferably adjusted or varied with the aid of a potentiometer that is arranged at an easily accessible location, for example, on the handlebar grip or the handlebar of the soil cultivation appliance. This enables the user to easily vary the motor speed, for example, by turning the handlebar grip.

The described soil cultivation appliance preferably comprises an electromechanical control for reversing the polarity of the rotary current motor and thusly reversing the rotating direction. The polarity reversal is triggered with a switching element that is preferably mounted on the handlebar grip of the appliance. The electromechanical control also comprises a speed limiter for limiting the speed of the rotary current motor in the reverse mode. This speed limiter limits the maximum speed in the reverse mode to less than 50% of the maximum speeds attainable in the forward mode.

According to one additional development of the described appliance, the electromechanical control is connected to another switching element and realized such that the rotary current motor is only supplied with power if the user continuously holds the additional switching element in the depressed position against the force of a spring. The power supply is interrupted when the user releases this switching element. This additional switching element in the form of a so-called dead man's switch is preferably arranged on the handlebar grip or the handlebar and assists in preventing accidents. The electromechanical control is also realized in such a way that both switching elements need to be actuated simultaneously in order to operate the appliance. This prevents the appliance from being unintentionally started. In addition, an electric interlocking system is preferably provided between the two switching elements in order to ensure that the appliance can only be changed over between the forward mode and the reverse mode when the electrical operation of the appliance is interrupted.

The adjusting device for adjusting the speed preferably forms part of the electromechanical control. The adjusting device can be electrically integrated into the control circuit if it is realized in the form of a potentiometer. The control comprises a microprocessor in one embodiment of the invention. This means that an adjusting device in the form of a potentiometer is not required in this case. The speed is adjusted, for example, with the switching element for changing over between the forward mode and the reverse mode, wherein the speed can be increased or decreased by depressing this switching element for a certain period of time. The variation of the frequency or the speed, respectively, is achieved by feeding a 0-10 V, 4-20 mA signal to the corresponding input of the frequency converter.

A very user-friendly operation of the soil cultivation appliance can be achieved with the latter embodiments of the soil cultivation appliance, particularly those with reversible rotating direction, because the user is able to easily release a stuck soil cultivation appliance by switching into the reverse mode.

In another advantageous embodiment, the frequency converter is realized in such a way that it not only delivers the drive voltage for the rotary current motor, but also a direct voltage for operating the electromechanical control. This makes it possible to additionally reduce the weight of the appliance because a separate power transformer is no longer required.

Another advantage of the described soil cultivation appliance can be seen in that no additional gears are required. The soil cultivation appliance can be operated in the forward as well as in the reverse mode by directly connecting the cultivating tool to the rotary current motor via a worm gear.

### BRIEF DESCRIPTION OF THE FIGURES

The soil cultivation appliance according to the invention is briefly described once again below with reference to one embodiment that is illustrated in the figures. The figures show:

FIG. 1, a highly schematic representation of a soil cultivation appliance according to the present invention;

FIG. 2, a schematic representation of the electrical components of the soil cultivation appliance according to the invention;

FIG. 3, an exemplary circuit for realizing the electromechanical control of the soil cultivation appliance according to the invention, and

FIG. 4, an exemplary torque curve of the rotary current motor of the soil cultivation appliance according to the invention.

### WAYS FOR REALIZING THE INVENTION

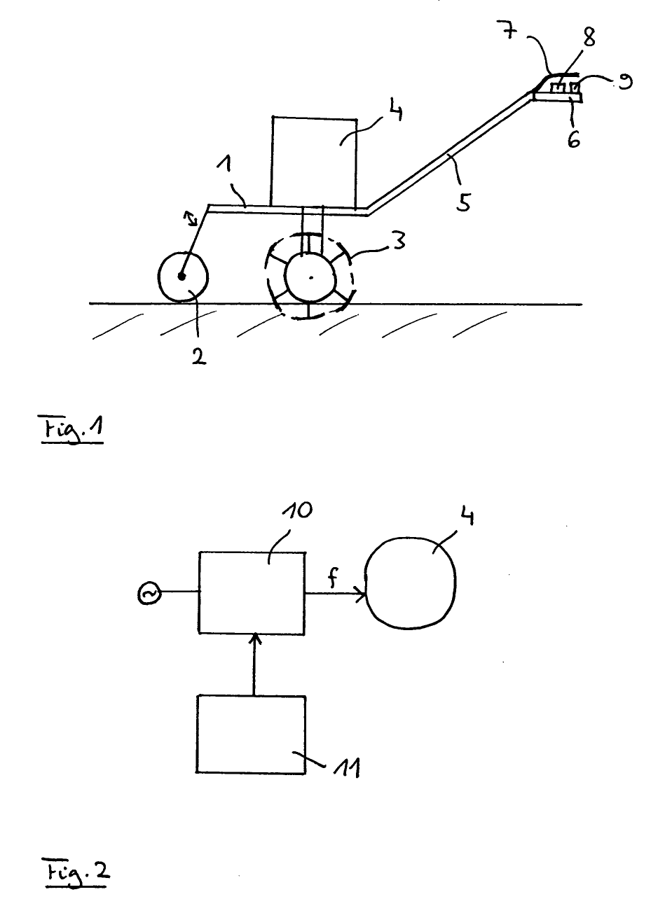

FIG. 1 shows a highly schematic representation of one typical design of a soil cultivation appliance that may also be used for the soil cultivation appliance according to the present invention. The soil cultivation appliance usually comprises a frame 1 that may be provided with a fold-down wheel 2 for transporting the appliance. A hoeing or tilling tool 3 is rotatively suspended on the frame 1 such that it digs into the soil. The tool 3 is driven by an asynchronous rotary current motor 4 that is connected to the tool 3, for example, via a worm gear. A steering arm 5 with a handlebar grip or handlebar 6 is mounted on the frame 1 and enables the user to steer the soil cultivation appliance. Two switching elements 7, 8 as well as a potentiometer 9 are arranged on the handlebar grip 6. Electric lines are provided for connecting the switching elements 7, 8 and the potentiometer 9 to an electromechanical control of the rotary current motor 4 that is not illustrated in this figure.

In order to distinguish between an intentional and an unintentional start of the appliance, two independent electromechanical switching functions need to be activated in this particular soil cultivation appliance. The switching element 7 in the form of a prestressed handle serves as an emergency stop. This switching element 7 needs to be constantly held in the activated position by the user during the operation of the soil cultivation appliance. Once this switching element 7 is released, it immediately assumes its idle position under the influence of a spring force such that the power supply between the frequency converter and the rotary current motor 4 is interrupted. The second switching element 8 is realized in the form of a pushbutton with a neutral position (center position with no switching function) as well as a forward and reverse position in the embodiment shown. This makes it possible to select the rotating direction of the rotary current motor and therefore the driving direction of the soil cultivation appliance.

The appliance is started by actuating or depressing the first switching element 7 and setting the switching element 8 for selecting the driving direction accordingly. The motor starts as soon as a driving direction is selected. The motor speed or driving speed can be varied with the aid of the easily accessible potentiometer 9. Alternatively, it would also be possible to utilize an electronic microprocessor in order to integrate the speed adjusting function into the switching element for selecting the forward or reverse mode, i.e., the speed is increased or decreased based on the time during which the switching element is depressed in the forward position or the reverse position.

The electromechanical control limits the maximum speed or driving speed when the reverse mode is selected. This minimizes the risk of accidents due to the difficult handling of the machine. An additional safety in the form of an electrical interlocking system is also installed between the switching element 7 for the emergency stop and the switching element 8 for selecting the forward or reverse mode. This ensures that the driving direction can only be changed after the power supply between the frequency converter and the rotary current motor of the appliance is interrupted.

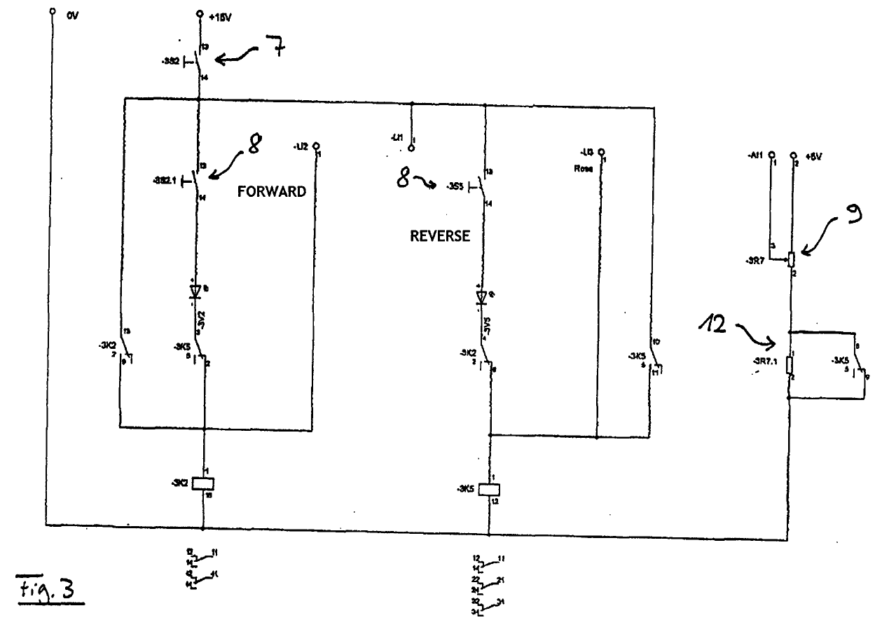

FIG. 2 schematically shows the essential electrical components of the soil cultivation appliance according to the invention. This figure shows the motor 4 that is supplied with a drive voltage by the frequency converter 10. The potentiometer 9 makes it possible to variably adjust the frequency of the drive voltage over a broad frequency range that lies between approximately 5 Hz and 120 Hz in the embodiment shown. The potentiometer 9 forms part of the electromechanical control 11 that serves for controlling the operating mode (forward-reverse) of the motor 4 with the aid of the corresponding switching elements 7, 8 shown in FIG. 1.

The motor used in the described embodiment consists of a commercially available three-phase rotary current motor with four poles that operates with an alternating voltage of 220 V, wherein said motor is adapted in such a way that a nearly constant torque is achieved, i.e., a torque that the varies by less than 10% over the entire speed range of the motor that covers speeds between 10 and 3600 rpm and can be adjusted with the potentiometer 9. For this purpose, the number of turns of the conventional rotary current motor was reduced from 62 turns to 42 turns in order to also attain a sufficiently low inductive resistance for generating the required torque at the maximum operating frequency of 120 Hz. The adaptation of the conventional rotary current motor also resulted in a power increase from 1.1 to 1.7 kW. This demonstrates that the adaptation according to the invention makes it possible to maintain the torque approximately constant over a broad speed range and to generate the same power with a smaller and therefore lighter motor.

A rotary current limiter is used for limiting the frequency of the drive voltage for this motor to a maximum frequency of 35 Hz in the reverse mode.

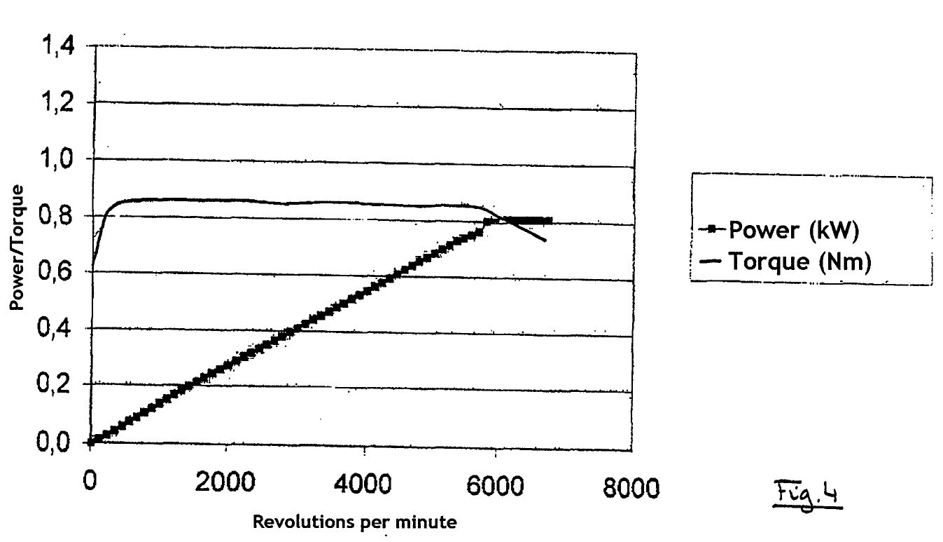

FIG. 3 shows an example for realizing the circuit of the electromechanical control used in the soil cultivation appliance according to the invention. Among other things, this circuit comprises the reverse mode speed limiter 12, the potentiometer 9, the emergency stop switching element 7 and the two switching functions of the switching element 8.

FIG. 4 shows the torque curve of another motor used for operating the soil cultivation appliance according to the invention. In this embodiment, a commercially available 0.37 kW rotary current motor that has two poles and operates on 220 V alternating voltage is adapted in such a way that it has a nearly constant torque over a speed range between 20 and 6800 rpm that can be adjusted with the aid of the potentiometer 9. For this purpose, a laminated core with 24 grooves is used in the motor instead of the originally provided laminated core with 18 grooves, and the winding is adapted accordingly. This measure surprisingly resulted in a practically constant torque over the broad speed range as illustrated in the figure.

### LIST OF REFERENCE SYMBOLS

1 Frame
2 Fold-down wheel
3 Cultivating tool
4 Rotary current motor
5 Steering arm
6 Handlebar grip or handlebar
7 First switching element
8 Second switching element
9 Potentiometer
10 Frequency converter
11 Electromechanical control
12 Speed limiter

1-14. (canceled)

15. An electromotive soil cultivation appliance for cultivating soil comprising a rotary hoe with an asynchronous rotary current motor for driving a rotatable cultivating tool, a frequency converter for generating a drive voltage of adjustable frequency for the rotary current motor, wherein the frequency converter is connected to a manually operated adjusting device for varying frequency of the drive voltage, and wherein the rotary current motor is constructed and arranged so that a nearly constant torque of the rotary current motor is maintained over a range of speeds of the motor and are adjustable by an adjusting device, wherein the nearly constant torque is maintained by adapting or selecting a number of poles and number of turns of the rotary current motor, and wherein a sufficiently high torque is maintained in a lower speed range by providing a correspondingly high number of turn grooves and/or poles.

16. The soil cultivation appliance according to claim 15, wherein the rotary current motor maintains said nearly constant torque over a speed range of the rotary current motor from 20 to 6500 rpm.

17. The soil cultivation appliance according to claim 15, wherein the rotary current motor maintains said nearly constant torque over a speed range of the rotary current motor from 10 to more than 3000 rpm.

18. The soil cultivation appliance according to claim 15, further comprising maintenance of a sufficiently low inductive resistance in a higher speed range by selecting a correspondingly small number of turns.

19. The soil cultivation appliance according to claim 15, wherein the torque of the rotary current motor varies by no more than 10% over a range of motor speeds.

20. The soil cultivation appliance according to claim 15, wherein the frequency converter and the adjusting device generate a drive voltage for the rotary current motor that has a maximum frequency in excess of 100 Hz.

21. The soil cultivation appliance according to claim 15, further comprising an electromechanical control for reversing polarity of the rotary current motor such that the soil cultivation appliance is operable in a forward mode or a reverse mode, wherein a speed limiter limits speed of the rotary current motor in the reverse mode to no more than 50% of a speed attainable in the forward mode.

22. The soil cultivation appliance according to claim 21, wherein the electromechanical control is connected to a first switching element and a second switching element that are actuated simultaneously in order to start the appliance, wherein the first switching element must be continuously held in a depressed position by a user against a force of a spring in order to operate the appliance and the second switching element provides for selection of the forward mode or the reverse mode.

23. The soil cultivation appliance according to claim 22, wherein the electromechanical control interrupts electrical operation of the appliance for changing over between the forward mode and the reverse mode.

24. The soil cultivation appliance according to claim 21, wherein the frequency converter has a direct voltage output for supplying the electromechanical control with power.

25. The soil cultivation appliance according to claim 21, wherein the electromechanical control comprises a microprocessor control.

26. The soil cultivation appliance according to claim 15, wherein the adjusting device comprises a potentiometer.
